(19) United States
(12) Patent Application Publication
(10) Pub. No.: US 2014/0320659 A1
(43) Pub. Date: Oct. 30, 2014

(54) DRIVE RECORDER AND DISPLAY DEVICE

(71) Applicant: Sharp Kabushiki Kaisha, Osaka-shi, Osaka (JP)

(72) Inventor: Shotaro Kaneyoshi, Osaka-shi (JP)

(73) Assignee: Sharp Kabushiki Kaisha, Osaka-shi, Osaka (JP)

(21) Appl. No.: 14/359,917

(22) PCT Filed: Nov. 28, 2012
(86) PCT No.: PCT/JP2012/007637

§ 371 Date: May 22, 2014

(30) Foreign Application Priority Data
Dec. 5, 2011 (JP) 2011-265886

(51) Int. Cl. H04N 5/77; B60R 11/02; B60R 1/00

(52) U.S. Cl. CPC H04N 5/77; B60R 1/00; B60R 11/0229
USPC 348/148

(57) ABSTRACT

To reduce manufacturing costs and facilitate analysis of the conditions of occurrence of an accident, a drive recorder includes a vehicle state detector (20, 30, 40) configured to detect a state of a vehicle, an imager (50) configured to capture images of surroundings of the vehicle, a storage controller (10) configured to control storage operation to store vehicle state data corresponding to the state of the vehicle and captured image data corresponding to the images captured by the imager, a display device (80) configured to carry out displaying based on display image data input to the display device, in which the display device (80) includes a nonvolatile memory (85) configured to store initial-setting data for controlling display operation, and the storage controller (10) causes the nonvolatile memory (85) of the display device (80) to store the captured image data of the images captured by the imager (50).

### TECHNICAL FIELD

The present disclosure relates to drive recorders configured to store data indicative of the state of an automobile and captured images of the outside of the automobile when the automobile is suddenly braked for example, and to display devices for use with the drive recorders.

### BACKGROUND ART

For example, a drive recorder for use in an automobile is configured to determine a point where the automobile was suddenly braked on the basis of outputs from an acceleration sensor, and to store data indicative of the state of the automobile at around the point and captured images of the outside of the automobile (see, e.g., Patent Document 1). The drive recorder thus configured is very useful because it facilitates later analysis of conditions under which an automobile accident occurred by means of the images and the like stored at the time of the accident.

### CITATION LIST

### PATENT DOCUMENT

PATENT DOCUMENT 1: Japanese Unexamined Patent Publication No. 2010-20485

### SUMMARY OF THE INVENTION

### Technical Problem

In order to store captured image data and the like as described above, drive recorders unavoidably include a relatively large-capacity storage device, which tends to increase the prices of the drive recorders. Consequently, the use of the drive recorders is presently limited to particular industries such as the transportation industry. Under these circumstances, inexpensive drive recorders which are configured to store a reduced amount of data are also used. However, these unsophisticated drive recorders, which store only data indicative of the state of an automobile and the like without storing images, impose considerable limitations on examination and analysis of the conditions under which an accident occurred.

It is therefore an object of the present disclosure to reduce costs of manufacturing drive recorders while facilitating analysis and examination of the conditions of occurrence of an accident.

### Solution to the Problem

A first aspect of the present disclosure relates to a drive recorder including: a vehicle state detector configured to detect a state of a vehicle; an imager configured to capture images of surroundings of the vehicle; a storage controller configured to control storage operation to store vehicle state data corresponding to the state of the vehicle and captured image data corresponding to the images captured by the imager; and a display device configured to carry out displaying based on display image data input to the display device, wherein the display device includes nonvolatile memory configured to store initial-setting data for controlling display operation, and the storage controller is configured to cause the nonvolatile memory of the display device to store the captured image data of the images captured by the imager.

The drive recorder thus configured can store the captured image data in the nonvolatile memory which is provided in the display device and stores the initial-setting data, and accordingly, does not need to include, in the body of the drive recorder for example, a storage device configured to store the captured image data. Specifically, nonvolatile memory in which initial-setting data are stored is generally regarded as read-only memory. The inventor of the present disclosure became aware that recent technologies have made it possible to configure memory of this type to be writable, and that along with increases in the degree of integration of semiconductor integrated circuits, memory having a relatively large capacity as compared to the amount of initial-setting data is sometimes used. The inventor thus found that utilization of available space of such memory makes it relatively easy to store a minimum amount of captured image data indicative of conditions of occurrence of an accident or the like without increasing the number of components of a drive recorder, and accordingly, the utilization enables establishment of a simple and inexpensive system for storing images, and thereby has made the invention disclosed herein. Thus, according to the present disclosure, it is possible to reduce costs of manufacturing drive recorders while facilitating analysis and examination of the conditions of occurrence of an accident.

A second aspect of the present disclosure relates to the drive recorder of the first aspect, wherein the storage controller is configured to cause the nonvolatile memory to store the captured image data at least periodically or when the vehicle state detector detects a predetermined state of the vehicle.

This configuration makes it easy to cause the nonvolatile memory to store data of images captured immediately before and at around occurrence of an accident, for example.

A third aspect of the present disclosure relates to the drive recorder of the first or second aspect, wherein the display device further includes a display processor configured to perform display processing for carrying out displaying based on the display image data input to the display device, and the captured image data are stored in the nonvolatile memory through the display processor.

This configuration makes it possible to cause the display processor to sort the image data into the display image data and the captured image data to be stored in the nonvolatile memory, thereby simplifying transmission of the image data to be input to the display device.

A fourth aspect of the present disclosure relates to the drive recorder of the first or second aspect, wherein the display device further includes a display processor configured to perform display processing for carrying out displaying based on the display image data input to the display device, and the captured image data bypass the display processor to be stored in the nonvolatile memory.

With this configuration, the display processor is allowed to carry out only display processing mainly based on the display image data. Accordingly, the configuration of the display processor can be easily simplified.

A fifth aspect of the present disclosure relates to the drive recorder of any one of the first to fourth aspects, wherein the storage controller is configured to cause the nonvolatile memory to further store the vehicle state data.

With this configuration, the captured image data can be easily brought into correspondence with the vehicle state data, thereby further facilitating analysis and examination of the conditions of occurrence of an accident.

A sixth aspect of the present disclosure relates to the drive recorder of any one of the first to fifth aspects, wherein the storage controller is configured to cause the nonvolatile memory to store the captured image data which have been compressed.

With this configuration, the number of screen images stored in the nonvolatile memory can be easily increased.

A seventh aspect of the present disclosure relates to the drive recorder of any one of the first to sixth aspects, wherein the captured image data corresponding to at least one screen image are input to the display device while the display image data corresponding to screen images are input to the display device.

This configuration makes it possible to cause the display device to store the captured image data in parallel with displaying of images.

### ADVANTAGES OF THE INVENTION

The present disclosure makes it possible to reduce costs of manufacturing drive recorders while facilitating analysis and examination of conditions of occurrence of an accident.

### BRIEF DESCRIPTION OF THE DRAWINGS

FIG. 1 is a block diagram illustrating a main portion of a drive recorder of Embodiment 1.

FIG. 2 is a block diagram illustrating a main portion of a liquid crystal display device 80 of Embodiment 1.

FIG. 3 is a flow chart showing operation which the drive recorder of Embodiment 1 performs to record captured image data.

FIG. 4 illustrates an example of image data input to the liquid crystal display device 80 of Embodiment 1.

FIG. 5 is a block diagram illustrating a main portion of a liquid crystal display device 80 of Embodiment 2.

FIG. 6 is a flow chart showing operation which the drive recorder of Embodiment 3 performs to record captured image data.

FIG. 7 illustrates an example of image data input to the liquid crystal display device 80 of Embodiment 4.

### DESCRIPTION OF EMBODIMENTS

As embodiments of the present disclosure, drive recorders each having a liquid crystal display device will be described below in detail with reference to the drawings. Note that components having an equivalent function are denoted by the same reference character throughout the embodiments and the variation thereof, and detailed description of such components is not repeated.

### Embodiment 1

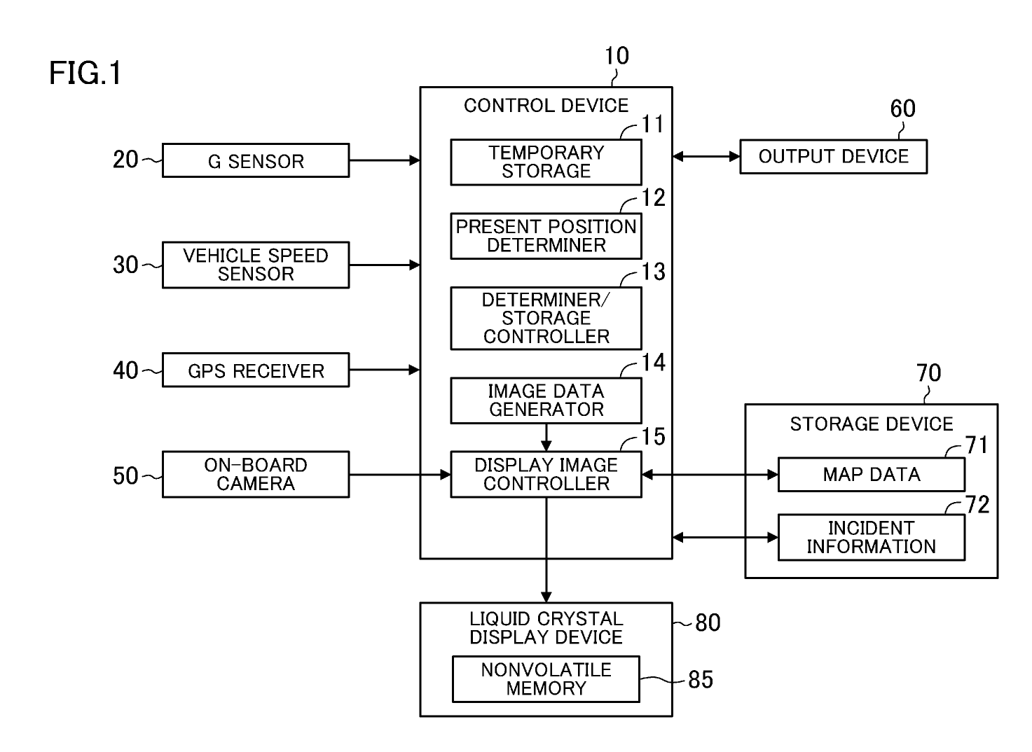

As illustrated in FIG. 1 for example, a drive recorder according to Embodiment 1 of the present disclosure includes a control device 10, a G sensor 20, a vehicle speed sensor 30, a GPS receiver 40, an on-board camera 50, an output device 60, a storage device 70, and a liquid crystal display device 80. The control device 10 is connected to each of the other components.

For example, the G sensor 20 is configured to detect acceleration of a vehicle body with respect to three directions: the fore-and-aft direction, the side-to-side direction, and the vertical direction.

The vehicle speed sensor 30 is configured to detect a speed at which the vehicle is moving based on a rotational speed of the wheels, for example.

The GPS receiver 40 is configured to receive a radio waves transmitted from GPS satellites and to output to the control device 10 data to be used for detection of the position of the vehicle.

The on-board camera 50 is configured to capture images of the surroundings of the vehicle for example and to output the data of the captured images to the control device 10.

The output device 60 is configured to give an alarm to the user by means of a speaker or a lamp, for example.

The storage device 70 is configured to store, e.g., map data 71 including road data indicative of road positions and image data of maps, and incident information 72 concerning, e.g., points at which the driver experienced potentially dangerous sudden incidents and near-misses.

The control device 10 includes a microcomputer for example and controls, based on the outputs from the sensors and the like, storage operation to store data indicative of the conditions under which the vehicle was suddenly braked. The control device 10 is provided with a temporary storage 11, a present position determiner 12, a determiner/storage controller 13, an image data generator 14, and a display image controller 15, for example.

The temporary storage 11 is configured to temporarily store data required by the control device 10 to perform control operation.

The present position determiner 12 is configured to determine the position of the vehicle based on the data transmitted from a plurality of GPS satellites.

The determiner/storage controller 13 is configured to cause the temporary storage 11 to temporarily accumulate outputs from the G sensor 20, the vehicle speed sensor 30, and the like, and to determine whether or not an abnormal event such as an accident has occurred on the basis of the accumulated outputs of the sensors and the like. When an abnormal event has occurred, the determiner/storage controller 13 causes the storage device 70 to store data of the state of the vehicle at around the time of the abnormal event as the incident information 72, and causes the liquid crystal display device 80 to store the captured image data, as will be detailed later.

The image data generator 14 is configured to generate image data for operational images to be displayed for operating the drive recorder and data for images to be displayed for car navigation.

The display image controller 15 is configured to perform selective switching between the image data output from the on-board camera 50, those output from the display image controller 15, and those output from the storage device 70, and to output the selected data to the liquid crystal display device 80.

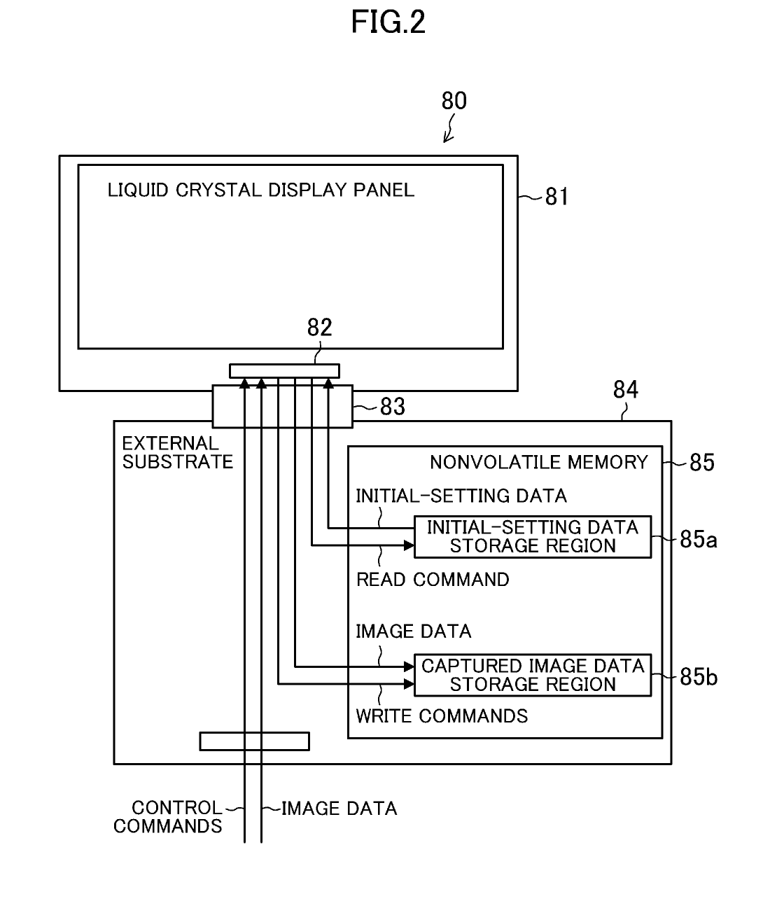

Specifically, the liquid crystal display device 80 includes a liquid crystal display panel 81 and an external substrate 84 which are connected to each other via a flexible substrate 83, as illustrated in FIG. 2. The liquid crystal display panel 81 includes an LSI 82 which is configured to process image signals and to generate driving signals in order to display images. The external substrate 84 includes a nonvolatile memory 85 which is, e.g., electrically erasable programmable read-only memory (EEPROM). The nonvolatile memory 85 includes an initial-setting data storage region 85a and a captured image data storage region 85b. In the initial-setting data storage region 85a, initial-setting data for controlling display operation of the liquid crystal display device 80 are stored. In the captured image data storage region 85b, image data of the images which the on-board camera 50 captures on the occurrence of an abnormal event are stored, as will be described later.

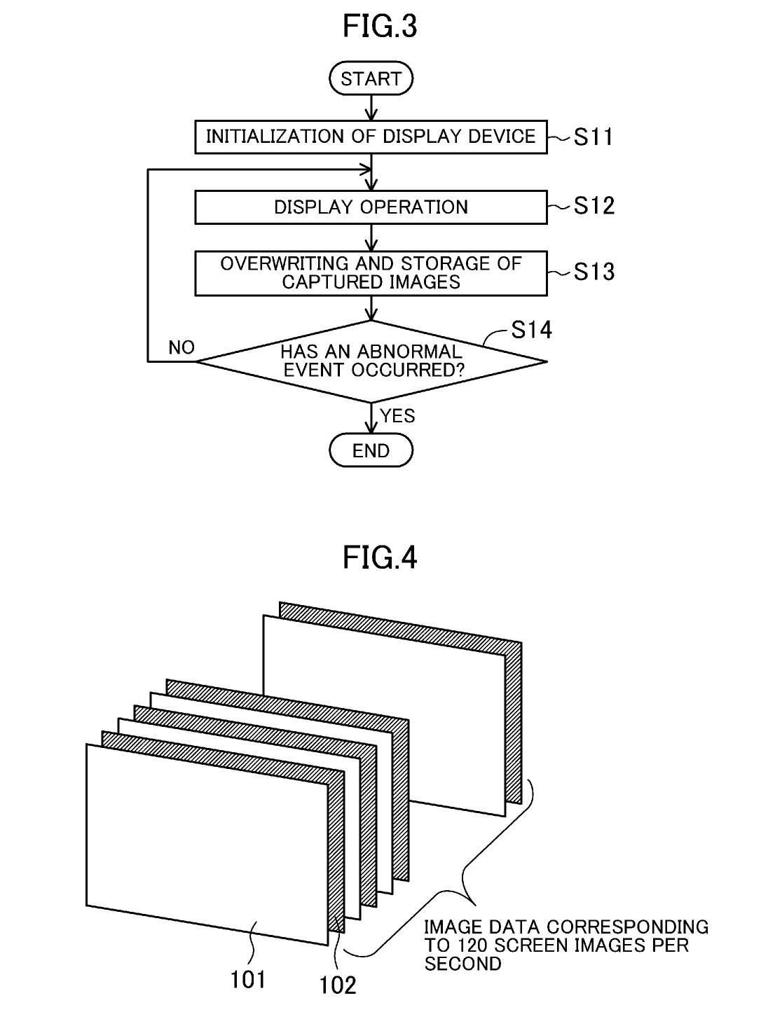

Next, how the drive recorder having the above configuration operates to store the captured image data will be described with reference to FIG. 3.

(S11) When the drive recorder is turned on, the LSI 82 of the liquid crystal display device 80 first outputs a read command to the nonvolatile memory 85, and the initial-setting data are read from the initial-setting data storage region 85a, thereby initializing an operational mode of the liquid crystal display device 80, settings of a power source and a controller, and the like.

(S12) Subsequently, as illustrated in FIG. 4 for example, the display image controller 15 of the control device 10 sends image data corresponding to 120 screen images each second to the LSI 82 of the liquid crystal display device 80. Specifically, display image data 101 corresponding to 60 screen images and storage image data 102 corresponding to 60 screen images are transmitted each second in such a manner that the screen images of the display image data 101 alternate with the screen images of the storage image data 102. Thus, images are displayed on the liquid crystal display panel 81 based on the transmitted display image data 101. The display image data 101 and the storage image data 102 may be distinguished from each other according to control commends sent from the control device 10 to the liquid crystal display device 80, or control or attribute signals equivalent to the control commends. Alternatively, the image data 101 and 102 may be distinguished from each other by judging if each of the screen images is odd-numbered or even-numbered, in synchronization with transmission of the data.

(S13) The storage image data 102 sent from the control device 10 pass through the LSI 82 of the liquid crystal display device 80, are separated from the display image data 101, and then, sent to the nonvolatile memory 85. At the same time, the LSI 82 automatically and periodically outputs write commands (write signals) to the nonvolatile memory 85. Thus, the storage image data 102 are written to the captured image data storage region 85b. When the captured image data storage region 85b has no free space or free space lower than a predetermined value, the image data are overwritten in the order in which they were written, for example.

(S14) Next, the determiner/storage controller 13 of the control device 10 determines whether or not an abnormal event such as an accident has occurred based on the outputs from the G sensor 20, the vehicle speed sensor 30, and the like. When it is determined that no abnormal event has occurred, the process returns to (S 12) and the display operation and the storage of the captured images are repeated. On the other hand, when it is determined that an abnormal event has occurred, the control device 10 stops transmitting the storage image data 102 to the liquid crystal display device 80, or a command or a control signal instructing to stop writing is input to the liquid crystal display device 80, thereby stopping writing of the image data to the nonvolatile memory 85.

Thus, the drive recorder of this embodiment is configured such that the storage image data 102 captured by the on-board camera 50 are sent from the control device 10 to the liquid crystal display device 80 to be stored in the nonvolatile memory 85 where the initial-setting data are stored. Consequently, without a large-capacity storage device which might be installed as the storage device 70, the drive recorder thus configured enables analysis and examination of an accident by displaying the images having been captured on the occurrence of the accident on the liquid crystal display panel 81 after the accident, or by allowing download of the captured images to other devices after the accident.

### Variation

Although the above embodiment exemplifies the configuration in which the LSI 82 automatically outputs the write commands to the nonvolatile memory 85 (i.e., the configuration in which the liquid crystal display device 80 itself has at least part of the function of a storage controller, the present disclosure is not limited to this configuration. A configuration in which the control device 10 outputs the write commands together with the storage image data 102, and the commands and the data are sent to the nonvolatile memory 85 via the LSI 82 of the liquid crystal display panel 81 may be adopted into the present disclosure.

The captured image data may be compressed to be stored.

It is sufficient to store the captured image data in an amount corresponding to at least one screen image, as necessary.

The nonvolatile memory 85 may store not only the captured image data but also other data indicative of the state of the vehicle, such as GPS information.

The nonvolatile memory 85 does not have to be provided on the external substrate 84, and may be provided inside the liquid crystal display panel 81 or may be formed integrally with the LSI 82, for example.

### Embodiment 2

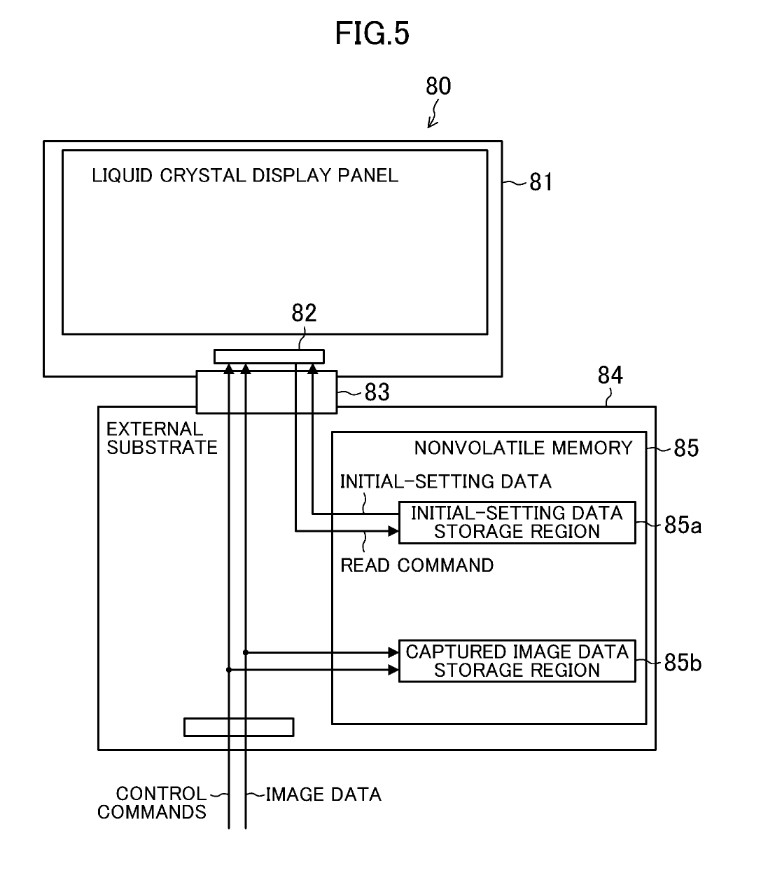

The storage image data 102 and the write commands to be sent to the nonvolatile memory 85 do not have to pass through the LSI 82 of the liquid crystal display panel 81 to be input to the nonvolatile memory 85, and may be directly input to the nonvolatile memory 85 from the control device 10, as illustrated in FIG. 5 for example.

### Embodiment 3

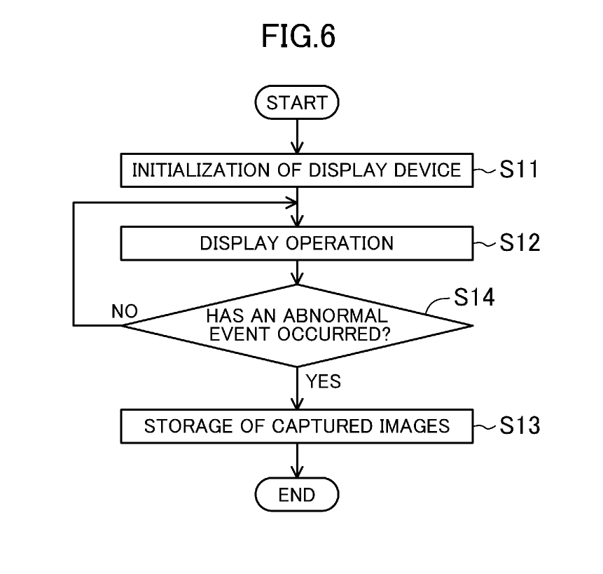

The storage of the storage image data 102 in the nonvolatile memory 85 do not have to be carried out periodically (constantly) in the above described manner. For example, as illustrated in FIG. 6, the storage of the storage image data (S13) may be carried out only when the determiner/storage controller 13 of the control device 10 determines that an abnormal event has occurred (Yes in S14). If this is the case, when it is determined that no abnormal event has occurred, only the display operation (S12) by the liquid crystal display panel 81 based on the display image data 101 may be repeated.

In this embodiment, the write commands may be caused to pass through the LSI 82 of the liquid crystal display panel 81 to be input to the nonvolatile memory 85 in a manner similar to Embodiment 1 (FIG. 2), or may be directly input to the nonvolatile memory 85 from the control device 10 in a manner similar to Embodiment 2 (FIG. 5).

### Embodiment 4

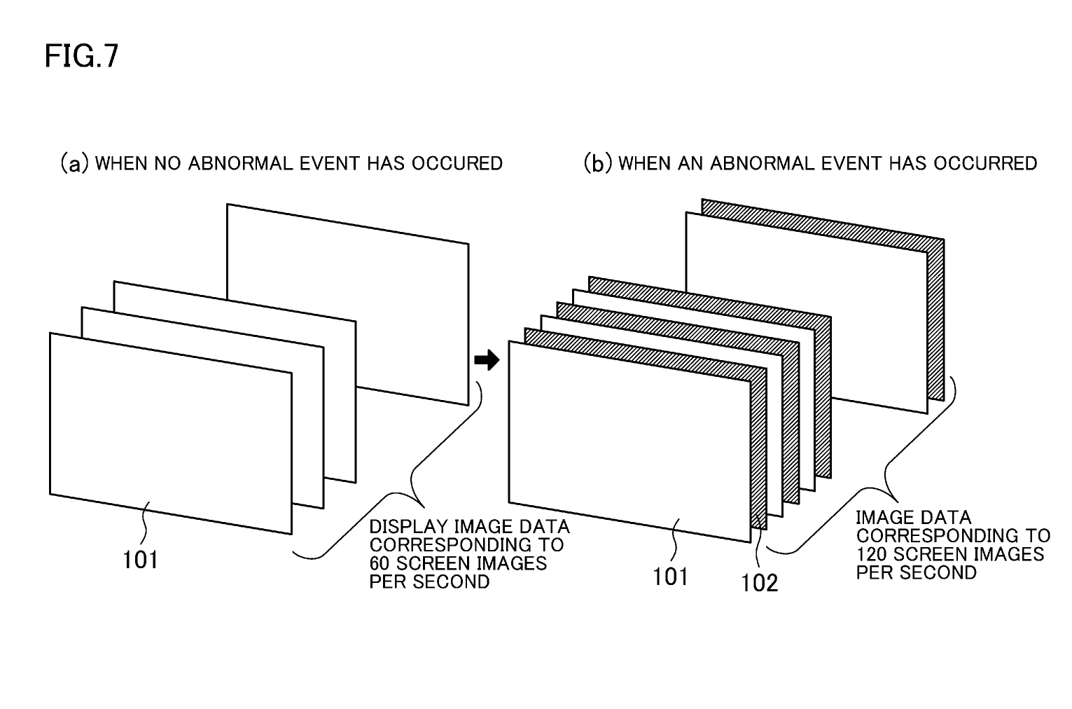

In a drive recorder configured such that the storage image data 102 are stored only when an abnormal event has occurred as described in Embodiment 3, transmission of the storage image data 102 may take place only when an abnormal event has occurred. Specifically, in the drive recorder according to Embodiment 4, when the determiner/storage controller 13 of the control device 10 determines that no abnormal event has occurred, the display image controller 15 of the control device 10 transmits, to the liquid crystal display device 80, the display image data 101 corresponding to 60 screen images each second as illustrated in FIG. 7(a) for example, and the liquid crystal display panel 81 displays images based on the data 101. On the other hand, when it is determined that an abnormal event has occurred, the data 101 and 102 are transmitted at a transmission rate of 120 screen images per second, as illustrated in FIG. 7(b). Specifically, the captured image data of the images captured by the on-board camera 50 are output as the storage image data 102 in such a manner that the screen images of the storage image data 102 are each output between adjacent ones of the screen images of the display image data 101. At the same time, control commands instructing to store the storage image data 102 are output, and the storage image data 102 are stored in the captured image data storage region 85b.

Also in Embodiment 4, the write commands may be caused to pass through the LSI 82 of the liquid crystal display panel 81 to be input to the nonvolatile memory 85 in a manner similar to Embodiment 1 (FIG. 2), or may be directly input to the nonvolatile memory 85 from the control device 10 in a manner similar to Embodiment 2 (FIG. 5).

Further, even when an abnormal event has occurred, the transmission rate of the whole data may be kept to 60 screen images per second by reducing the display image data 101 to a half.

Furthermore, the drive recorder may be configured such that only the storage image data 102 are transmitted when an abnormal event has occurred.

### INDUSTRIAL APPLICABILITY

As described above, the present disclosure is useful for drive recorders configured to store data of the state of an automobile and captured images of the outside of the automobile when the automobile is suddenly braked for example, and for display devices for use with the drive recorders.

### DESCRIPTION OF REFERENCE CHARACTERS

10 Control device
11 Temporary storage
12 Present position determiner
13 Determiner/storage controller
14 Image data generator
15 Display image controller
20 G sensor
30 Vehicle speed sensor
40 GPS receiver
50 On-board camera
60 Output device
70 Storage device
71 Map data
72 Incident information
80 Liquid crystal display device
81 Liquid crystal display panel
82 LSI
83 Flexible substrate
84 External substrate
85 Nonvolatile memory
85a Initial-setting data storage region
85b Captured image data storage region
101 Display image data
102 Storage image data

1. A drive recorder, comprising:
a vehicle state detector configured to detect a state of a vehicle;
an imager configured to capture images of surroundings of the vehicle;
a storage controller configured to control storage operation to store vehicle state data corresponding to the state of the vehicle and captured image data corresponding to the images captured by the imager; and
a display device configured to carry out displaying based on display image data input to the display device, wherein
the display device includes nonvolatile memory configured to store initial-setting data for controlling display operation, and
the storage controller is configured to cause the nonvolatile memory of the display device to store the captured image data of the images captured by the imager.

2. The drive recorder of claim 1, wherein
the storage controller is configured to cause the nonvolatile memory to store the captured image data at least periodically or when the vehicle state detector detects a predetermined state of the vehicle.

3. The drive recorder of claim 1, wherein
the display device further includes a display processor configured to perform display processing for carrying out displaying based on the display image data input to the display device, and
the captured image data are stored in the nonvolatile memory through the display processor.

4. The drive recorder of claim 1, wherein
the display device further includes a display processor configured to perform display processing for carrying out displaying based on the display image data input to the display device, and
the captured image data bypass the display processor to be stored in the nonvolatile memory.

5. The drive recorder of claim 1, wherein
the storage controller is configured to cause the nonvolatile memory to further store the vehicle state data.

6. The drive recorder of claim 1, wherein
the storage controller is configured to cause the nonvolatile memory to store the captured image data which have been compressed.

7. The drive recorder of claim 1, wherein
the captured image data corresponding to at least one screen image are input to the display device while the display image data corresponding to screen images are input to the display device.

8. A display device provided to the drive recorder of claim 1 and configured to carry out displaying based on the display image data input to the display device, the display device comprising:
the nonvolatile memory configured to store the initial-setting data for controlling the display operation, wherein
the nonvolatile memory of the display device is configured to store the captured image data of the images captured by the imager.
